(19) United States
(12) Patent Application Publication
(10) Pub. No.: US 2022/0260284 A1
(43) Pub. Date: Aug. 18, 2022

(54) AIR RECEIVER FOR SOLAR POWER PLANT

(71) Applicant: Heliogen Holdings, Inc., Pasadena, CA (US)

(72) Inventors: Steven Edward Schell, Arcadia, CA (US); Andrew Stephen Oles, Baltimore, MD (US); Paul Gauche, Arcadia, CA (US)

(21) Appl. No.: 17/650,210

(22) Filed: Feb. 7, 2022

Related U.S. Application Data
(60) Provisional application No. 63/149,436, filed on Feb. 15, 2021.

(51) Int. Cl. F24S 20/20; F24S 10/80; F24S 70/60; F24S 10/70

(52) U.S. Cl. CPC F24S 20/20; F24S 10/70; F24S 70/60; F24S 10/80

(57) ABSTRACT

An air receiver for use in a solar power plant receives sunlight from a plurality of heliostats focused on the air receiver via an aperture of the receiver to heat air in the cavity of the receiver. The heated air is directed out of the receiver via one or more output ports in fluid communication with the cavity. A solar power tower can include one or more receivers (e.g., oriented in different directions) and have outflow conduit(s) in fluid communication with the output ports. The outflow conduit(s) receive heated air from the one or more receivers and direct it toward one or both of a hot thermal storage tank and a heat utilization module (e.g., for use in generating electricity or facilitating an industrial process, such as a chemical reaction).

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The invention generally pertains to devices for capturing solar energy. In particular, the invention relates to an air receiver for a solar power plant.

### Description of the Related Art

Existing solar energy systems utilize solar panels to convert sunlight into electricity. However, existing solar energy systems have various drawbacks that make them inefficient and ineffective for capturing energy from the Sun and converting it to energy for use on an industrial and utility scale. One such drawback is the inability to provide energy at all times (e.g., at nighttime). Another drawback is the inability to use solar energy for industrial scale applications.

### SUMMARY

In accordance with one aspect of the disclosure, an air receiver for use in a solar power plant is provided that receives sunlight from a plurality of heliostats focused on the air receiver via an aperture of the receiver to heat air in the cavity of the receiver. The heated air is directed out of the receiver via one or more output ports in fluid communication with the cavity.

In accordance with another aspect of the disclosure, a solar power tower for use with a solar power plant is provided. The solar power tower includes one or more air receivers at a top portion of the tower. The one or more air receivers receive sunlight from a plurality of heliostats focused on the air receiver via an aperture of the receiver to heat air in the cavity of the receiver. The heated air is directed out of the receiver via one or more output ports in fluid communication with the cavity. The solar power tower includes one or more one or more outflow conduits in fluid communication with the output manifold and that receive heated air from the one or more receivers and direct it toward one or both of a hot thermal storage tank and a heat utilization module (e.g., for use in generating electricity or facilitating an industrial process, such as a chemical reaction).

In accordance with another aspect of the disclosure, a solar power plant is provided. The solar power plant includes a solar power tower and a plurality of heliostats arranged around at least a portion of the solar power tower and oriented to reflect sunlight toward one or more air receivers at a top portion of the tower. The one or more air receivers receive sunlight from a plurality of heliostats focused on the air receiver via an aperture of the receiver to heat air in the cavity of the receiver. The heated air is directed out of the receiver via one or more output ports in fluid communication with the cavity. The solar power tower includes one or more one or more inflow conduits in fluid communication with the output manifold and that receive heated air from the one or more receivers and direct it toward one or both of a hot thermal storage tank and a heat utilization module (e.g., for use in generating electricity or facilitating an industrial process, such as a chemical reaction).

In accordance with another aspect of the disclosure, a receiver for a solar power plant is provided. The receiver comprises a housing. The housing comprises an aperture on a front side of the housing, a plurality of side walls adjacent the aperture and extending rearward therefrom, and an absorber that extends rearward of the sidewalls, the absorber comprising a porous material with a plurality of pores that allow airflow across the absorber. A cavity is bounded by the aperture, the side walls and the absorber, and a plurality of parallel and spaced apart members extend across the aperture, a gap defined between each pair of members. The receiver also comprises a plurality of output ports proximate the absorber and in fluid communication with the cavity via the plurality of pores in the absorber, and an output manifold in fluid communication with the plurality of output ports. The aperture is configured to receive sunlight from one or more heliostats therethrough to heat air in the cavity via the absorber. The aperture is also configured to receive heated air via the gap between each pair of members, the heated air passing through the pores in the absorber and into the output ports and output manifold.

In accordance with another aspect of the disclosure, a solar power tower for a solar power plant is provided. The solar power tower includes one or more receivers at a top portion of the tower. Each receiver comprises a housing. The housing includes an aperture on a front side of the housing, a plurality of side walls adjacent the aperture and extending rearward therefrom, and an absorber that extends rearward of the sidewalls, the absorber comprising a porous material with a plurality of pores that allow airflow across the absorber. A cavity is bounded by the aperture, the side walls and the absorber, and a plurality of parallel and spaced apart members extend across the aperture, a gap defined between each pair of members. The receiver also comprises a plurality of output ports proximate the absorber and in fluid communication with the cavity via the plurality of pores in the absorber, and an output manifold in fluid communication with the plurality of output ports. The receiver also comprises a plurality of input ports affixed to one or more edges of the aperture and a second absorber adjacent openings of the input ports. The aperture is configured to receive sunlight from one or more heliostats therethrough to heat air in the cavity via the absorber. The aperture is also configured to receive heated air via the gap between each pair of members, the heated air passing through the pores in the absorber and into the output ports and output manifold. The second absorber is configured to receive sunlight directed outside said one or more edges of the aperture that heats the second absorber, which in turn heats air passing through the input ports and through one or more pores in the second absorber, the heated air thereafter directed through the aperture into the cavity.

### BRIEF DESCRIPTION OF THE DRAWINGS

The present disclosure is illustrated by way of example and not limitation in the figures of the accompanying drawings, and in which:

FIG. 1 is a perspective view of an air receiver;

FIG. 2 is a perspective view of a portion of a solar power tower with a plurality of air receivers;

FIG. 3 is a horizontal cross section of an air receiver;

FIG. 4 is a horizontal cross section of an air receiver;

FIG. 4A is a horizontal cross section of an air receiver, in a different operating implementation;

FIG. 4B is a schematic front view of an aperture of the receiver with horizontally extending members across the aperture;

FIG. 4C is a schematic front view of an aperture of the receiver with a grid of members extending across the aperture;

FIG. 4D is a cross-sectional view of a member transverse to its length;

FIG. 4E is a cross-sectional view of a member transverse to its length;

FIG. 5 is a vertical cross section of an air receiver;

FIG. 6 is a vertical cross section of an air receiver; and

FIG. 6A is a vertical cross section of an air receiver, in a different operating implementation;

FIG. 7 is a diagrammatic illustration of a solar power plant with an air receiver.

### DETAILED DESCRIPTION

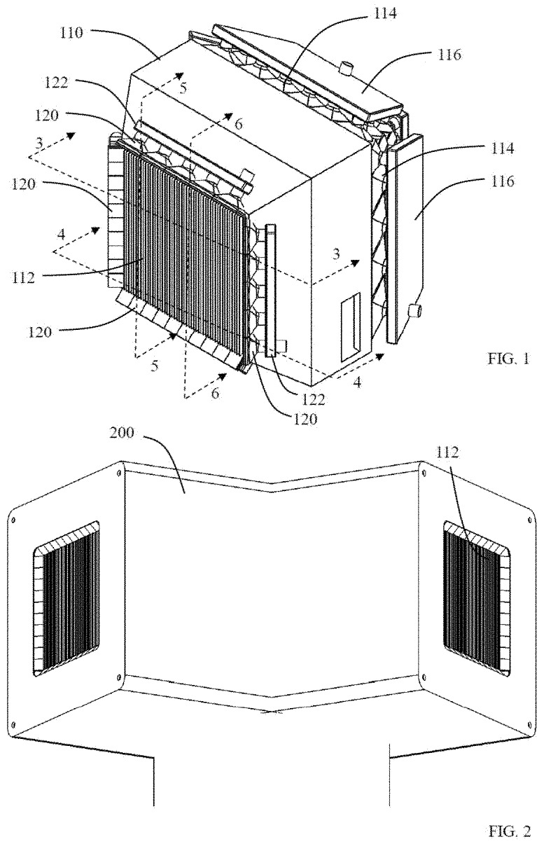

Described below is a novel air receiver for use in a solar power plant, such as in a power tower of a solar power plant. Illustrated in FIG. 1 is a perspective view of an air receiver 110. The air receiver 110 can receive sunlight and convert that sunlight to heat. The air receiver 110 includes an aperture 112 that receives sunlight that is aimed at the receiver, a plurality of output ports 114 via which heated air (e.g., generated in) the receiver is captured, and at least one output manifold 116 that channeling the heated air away from the receiver 110. The air receiver 110 further includes input ports 120 via which pre-heated air is introduced into the receiver and input manifolds 122 that direct the preheated air to the input ports 120.

As illustrated in FIG. 1, in one implementation the input ports 120 line the four edges of the aperture 112 in order to capture light spillage, e.g., light that was aimed at the aperture 112 but spilled outside the physical boundaries of the aperture 112. In other implementations, the input ports 120 can extend along less than an entire boundary of the aperture 112. The input ports 120 can capture light “spillage” and convert that light to heat that is then directed into the receiver 110. The heat generated through the conversion of light in the receiver 110, in addition to the preheated air coming from the input manifolds 122, effectively and advantageously increase the efficiency of the receiver 110 and maximize the utilization of sunlight.

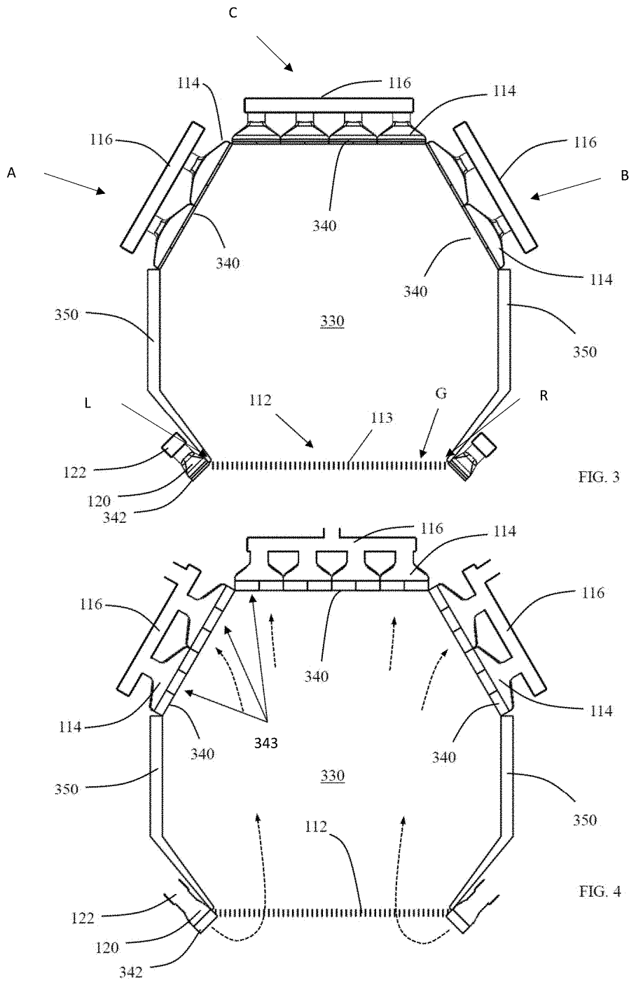

Illustrated in FIG. 2 is a perspective view of (e.g., a portion, an upper portion) a solar power tower 200 with a plurality of air receivers, such as air receivers 110, coinciding with apertures 112. Each receiver (e.g., air receiver 110) is oriented in a different direction to capture sunlight reflected from a different part of a field of heliostats (e.g., that is arranged around the solar power tower 200). For example, one air receiver (e.g., air receiver 110) may be oriented in a northern direction while another air receiver (e.g., air receiver 110) may be directed in a western direction, for example, depending on the layout of heliostats. In one implementation, the solar power tower 200 can have three air receivers, such as air receivers 110, spaced 120 degrees apart (e.g., where a field of heliostats that direct sunlight to the air receivers is arranged around the solar power tower 200). In another implementation, the solar power tower 200 can have four air receives, such as air receivers 110, spaced 90 degrees apart (e.g., where a field of heliostats that direct sunlight to the air receivers is arranged around the solar power tower 200).

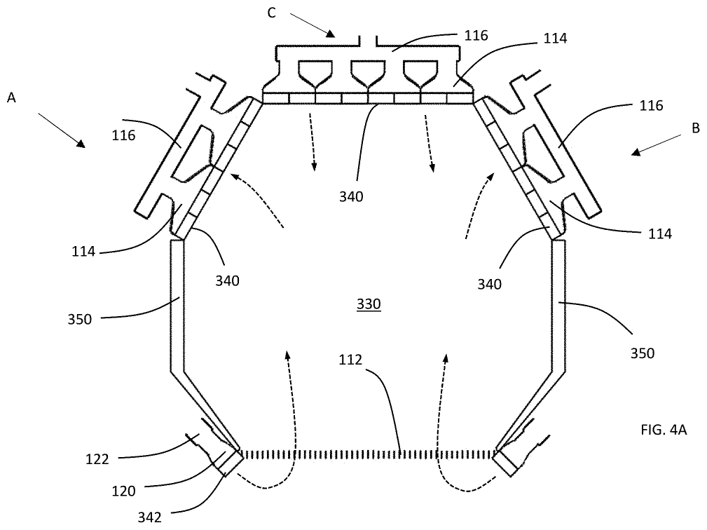

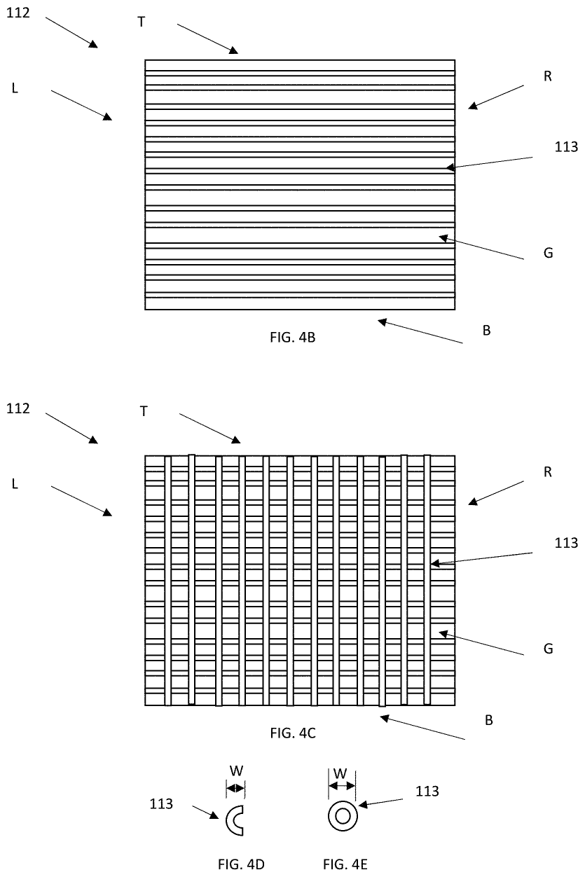

Illustrated in FIGS. 3 and 4 are cross sections of the air receiver 110 through horizontal planes (as shown by lines 3-3 and 4-4 in FIG. 1). As shown, the receiver 110 includes a cavity 330 (e.g., an open, unobstructed, hollow space) bounded by the aperture 112, an absorber 340, and a plurality of side walls 350. In one implementation, the side walls 350 can be made of a reflective insulating material. In one example, the side walls 350 can be made of ceramic wool. In another example, the side walls 350 can be made of ceramic fiber-board.

In one implementation, the air receiver 110 includes a plurality of members 113 that extend across the aperture 112 and are spaced apart from each other by a gap G. The gap G between members 113 can in one example be 4-5 cm to allow airflow between the members 113 in to the receiver 110. In other implementations, the gap G can be between 4-10 cm. However, the gap G can have other suitable values for use in the receiver 110. In one implementation the members 113 extend vertically across the aperture 112 (e.g., between a bottom edge (B) and a top edge (T) of the aperture 112), as shown in FIGS. 1 and 3-4, which can advantageously have higher stiffness. However, in other implementations the members can extend horizontally (e.g., between a left side edge and a right side edge of the aperture 112), as shown schematically in FIG. 4B. In still another implementation, the members can form a grid across the aperture 112, as shown schematically in FIG. 4C. In one implementation, the members 113 can be slats or strips (e.g., that extend linearly and have a rectangular cross-section transverse to a length of the member), as shown in FIGS. 1 and 3-4. In another implementation, the members 113 can be half-cylinders or semi-cylindrical rods (e.g., that extend linearly and have an annular semicircular cross-section transverse to a length of the member), as shown schematically in FIG. 4D, to advantageously inhibit (e.g., prevent) bending or vibration of the members 113. In still another implementation, the members 113 can be cylindrical or tubular rods (e.g., that extend linearly and have an annular circular cross-section transverse to a length of the member), as shown in FIG. 4E, to advantageously inhibit (e.g., prevent) bending or vibration of the members 113. The members 113 are made of a material that is advantageously transparent to radiation (e.g., in the solar spectrum including the visible range and infrared wavelengths). The material of the members 113 can also advantageously be opaque in the thermal infrared region. For example, the material of the members 113 can be transparent in the solar spectrum (e.g., approximately 380-2500 nm wavelength) and opaque in longer wavelength infrared radiation (e.g., greater than 2500 nm wavelength). The members 113 across the aperture can therefore be transparent to optical light to admit sunlight into the cavity 330, where the sunlight is absorbed. For example, wherever the sunlight impinges inside the cavity 330, for example impinges the absorber 340, the material (e.g., of the absorber 340) will emit blackbody radiation. By having the material of the members 113 be opaque in the thermal infrared region, the infrared radiation will advantageously be reflected by the members 113 back to the cavity 330 (e.g., without escaping past the members 113 and through the aperture 112), or absorbed by the members 113, to further heat the air in the cavity 330. Additionally, when the members 113 heat up (e.g., due to the infrared radiation from the material of the absorber 340), the heated members 113 heat air entering and/or circulating into the cavity 330 to thereby advantageously preheat said air entering (e.g., being circulated into) the cavity 330 via the aperture 112 (e.g., past the members 113).

In one implementation, the members 113 can be made of glass (e.g., Quartz or Silica Glass or fused silica). In another implementation, the members 113 can be made of doped silica (e.g., Sapphire). In another implementation, the members 113 can be made of transparent ceramics. The members 113 can have a cross-sectional width W of 1-2 cm transverse to the length of the member 113. However, the members 113 can have a cross-sectional width W of between about 1 cm and about 5 cm, or other widths suitable for use in the receiver 110. The members 113 can be arranged in a parallel manner across the width of the aperture 112. Advantageously, the members 113 absorb thermal radiation generated in the cavity 330, thereby inhibiting (e.g., preventing) the energy from escaping out of the receiver 110 through the aperture 112.

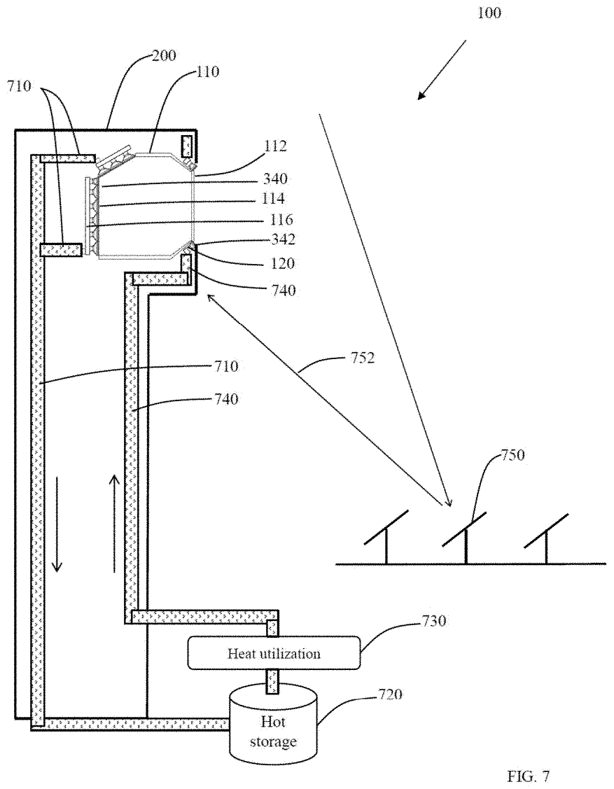

Sunlight that passes through the strips 113 (e.g., through or across the strips of glass) or between strips 113 via the gaps G at the aperture 112 generally impinge on the absorber 340. The absorber 340 can be adjacent the output ports 114 (e.g., disposed between the cavity 330 and the output ports 114). In one implementation, the absorber 340 is a porous material that converts the incoming sunlight into heat. In one implementation, the absorber 340 can be made from silicon carbide (SiC), such as a foam made from Silicon Carbide (SiC). In another implementation, the absorber 340 can be made from Iron-Chromium-aluminum (FeCrAl), such as a foam made from Iron-Chromium-aluminum (FeCrAl). In another implementation, the absorber 340 can be made from Iron-Chromium-aluminum (FrCrAl) foils, for example formed into micro-channels. In still another implementation, the absorber 340 can be made from a woven mesh of high-temperature materials, such as stainless steel or Inconel wire mesh, or ceramic fabric. Because it is porous (e.g., has pores 343), air can advantageously pass through the absorber 340, including the air heated by the absorber 340, and the heated air collected by the output ports 114 and output manifolds 116. That is, the output ports 114 are in fluid communication with the cavity 330 via the absorber 340. In the illustrated implementation, the absorber 340 is adjacent output ports 114, which are in fluid communication with output manifolds 116, on a first side A, a second side B and a third (rear) side C. In one implementation, heated air flows from the cavity 330 through the absorber 340 and into the output ports 114 and output manifolds 116 in the first, second and third sides A, B, C. In another implementation, at least one of the first, second and third sides A, B, C has air (e.g., from a return line, such as return line 740 shown in FIG. 7 and discussed further below) that is directed (e.g., flows) through the output manifold 116 and output ports 114 into the cavity 330 (see FIG. 4A), where it is preheated and advantageously balances the net power and temperature on the other sides. Said heated air can then be passed through the absorber 340, output ports 114 and output manifold 116 in the other sides, enhances stability and enables higher temperature operation. Though FIG. 4A shows the side C being the one through which air flows into the cavity 330, any one of the sides A, B, C can be the side through which air flows into the cavity 330 in the manner described above. In one implementation, two of the sides A, B, C can have air flow therethrough into the cavity 330.

Some sunlight that enters the aperture 112 impinges on the side walls 350 which can include insulation to inhibit (e.g., prevent) the loss of heat through radiation or convection. In one implementation, the insulation can include insulating material such as ceramic fiber board, which can be supported on a supporting structure (e.g., made of steel). In one implementation, the insulation can be a single wall of insulating material. In another implementation, the insulation can include multiple layers of material, with the outer layers (e.g., that face the cavity 330) are made of relatively higher temperature insulation material and are subjected to the highest temperatures and direct flux, and the inner layers (e.g., proximate the supporting structure are made of relatively lower temperature insulation material. The face of these insulating walls becomes hot, re-radiating energy to the rest of the cavity 330 including the absorbers 340 and the (glass) strips 113 that extend across the aperture 112.

As shown in FIGS. 3-4, the input ports 120 are affixed to the left (L) and right (R) edges of the aperture 112. As discussed above, the input ports 120 can also be affixed to upper and lower edges of the aperture 112. The face of the input ports 120 optionally include a porous absorber 342 for converting spillage sunlight into heat. The absorber 342 can be made of the same material as the absorber 340 described above. Preheated air that leaves the input ports 120 is therefore further heated by absorbers 342. In another implementation, the porous absorber 342 is excluded from the input ports 120, and air passes through open (e.g., unobstructed) ends of the input ports 120. This preheated air is then drawn into the aperture 112 between the vertical (glass) members 113 and into the receiver cavity 330. That preheated air is further preheated by convection from the hot (glass) members 113 before migrating to the back of the receiver 110 where it is further heated by the absorber 340 and collected by the output ports 114, which direct the heated air to the output manifolds 116.

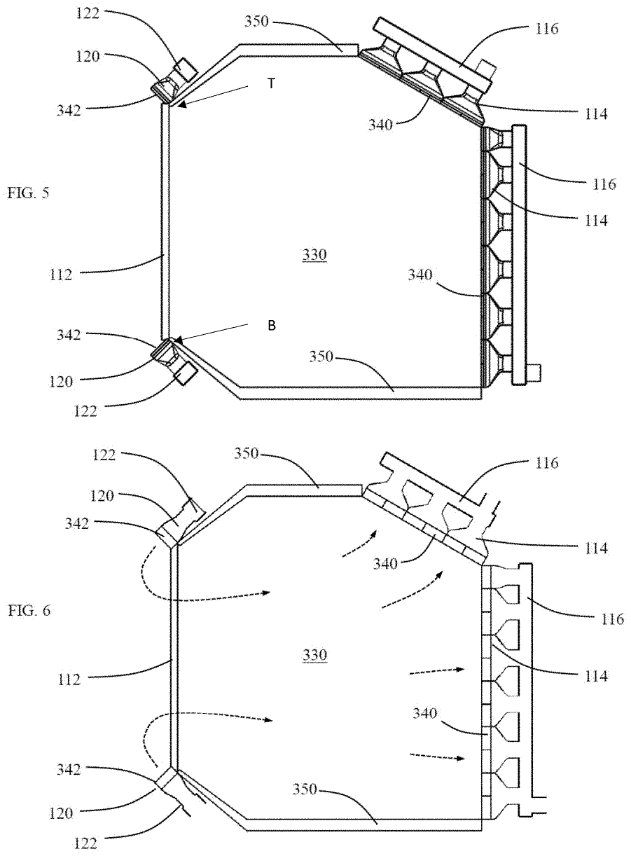

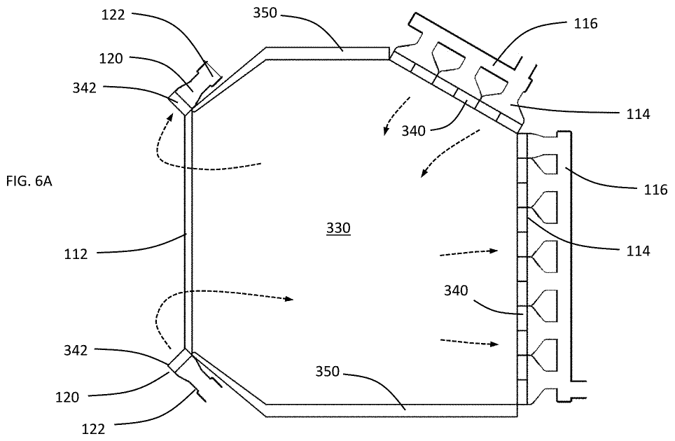

Illustrated in FIGS. 5 and 6 are cross sections of the air receiver 110 through vertical planes (as shown by lines 5-5 and 6-6 in FIG. 1). Again, the receiver 110 includes a cavity 330 bounded by the aperture 112, absorber 340, and side walls 350. In one implementation, the vertical members 113 at the aperture 112 are thin strips 113 (of glass) that are aligned in a parallel manner across the width of the aperture 112. Small gaps G (see FIG. 3) between the thin strips 113 (of glass) permit air to flow into the receiver 110. Together, the strips 113 (of glass) absorb thermal radiation generated in the cavity 330 and inhibit (e.g., prevent) it from escaping out of the receiver 110 through the aperture 112. Sunlight that passes through or between the strips 113 (e.g., of glass) at the aperture 112 generally impinge on the absorber 340, thereby heating the absorber 340. The pre-heated air can then pass through the absorber 340 (e.g., through apertures or pores 343 in the absorber 340) where it is further heated before being collected by the output ports 114 and output manifolds 116.

As shown, the input ports 120 are affixed to the upper and lower edges of the aperture 112. The face of the input ports 120 can optionally include a porous absorber 342 for converting spillage sunlight (as described above) into heat. The preheated air that leaves the input ports 120 is therefore further heated by the absorbers 342. This preheated air is then drawn into the aperture 112 between the vertical (glass) members 113 and into the receiver cavity 330, for example being further preheated by the hot (glass) members 113 on the way. That preheated air migrates to the back of the receiver 110 where it is further heated by the absorber 340 and collected by the output ports 114 (e.g., that are in fluid communication with apertures or pores 343 in the absorber 340). In another implementation, one or more of the input ports 120 along the upper edge of the aperture 112 draws air (e.g., operates in suction mode) through their associated absorber 342 and recirculate said air to other air supply lines (e.g., that direct air into the cavity 330), as shown in FIG. 6A, thereby advantageously capture buoyant losses of heated air and increase the operating efficiency of the receiver 110. In another implementation, the porous absorber 342 is excluded and air passes through open (e.g., unobstructed) ends of the input ports 120.

Illustrated in FIG. 7 is a diagrammatic illustration of a solar power plant 100 with the air receiver 110 installed in the solar power tower 200. Sunlight is reflected by a plurality of heliostat mirrors 750 and the reflected sunlight 752 is directed to the aperture 112. The sunlight is captured by the porous absorber material 340 adjacent (e.g., on) the output ports 114 of the receiver 110 and, sometimes, on the porous absorber material 342 on the input ports 120.

The air heated by the porous absorber material 340 on the output ports 114 is collected and transported via conduits 710 (e.g., that are in fluid communication with the output manifolds 116) to a hot thermal storage tank 720, which can store the heat from the heated air, before at least a portion of it is used to generate electricity or used in an industrial process, such as facilitate a chemical reaction, for example, at the heat utilization module 730. In one implementation, the hot thermal storage tank 720 can include a thermal storage material, such as a packed bed of rocks, for example Bauxite. In another implementation, the thermal storage material can alternatively or additionally include Alumina spheres. In another implementation, the thermal storage material can alternatively or additionally include bricks (e.g., honeycomb bricks) of firebrick or Alumina. The air that leaves the heat utilization module 730 is generally still warm, albeit cooler that the heated air in conduit 710. The warm air is pumped via conduit 740 back to the receiver 110 and re-introduced into the receiver via input ports 120 and absorber 342. If light spillage is occurring, the sunlight may heat the absorber 342 and the temperature of the preheated air further elevated before entering the receiver cavity 330.

Advantageously, the disclosed receiver 110, solar power tower 200 and solar power plant 100, allow for capture of heat from solar energy, and storage of said heat for use in generating electricity (e.g., at nighttime), for example to drive a turbine to generate electricity. The heat captured by the disclosed receiver(s) 110 can also advantageously be used in industrial processes, such as to facilitate a chemical reaction.

### ADDITIONAL EMBODIMENTS

In embodiments of the present invention, a receiver for a solar power plant, and a solar power tower for a solar power plant may be in accordance with any of the following clauses:

Clause 1. A receiver for a solar power plant, comprising:
a housing comprising
   an aperture on a front side of the housing,
   a plurality of side walls adjacent the aperture and extending rearward therefrom,
   an absorber that extends rearward of the sidewalls, the absorber comprising a porous material with a plurality of pores that allow airflow across the absorber,
   a cavity bounded by the aperture, the side walls and the absorber, and
   a plurality of parallel and spaced apart members that extends across the aperture, a gap defined between each pair of members;
a plurality of output ports proximate the absorber and in fluid communication with the cavity via the plurality of pores in the absorber; and
an output manifold in fluid communication with the plurality of output ports,
wherein the aperture is configured to receive sunlight from one or more heliostats therethrough to heat air in the cavity via the absorber, the aperture also configured to receive heated air via the gap between each pair of members, the heated air passing through the pores in the absorber and into the output ports and output manifold.

Clause 2. The receiver of Clause 1, wherein the members are made of glass.

Clause 3. The receiver of any preceding clause, wherein the members are configured to absorb thermal radiation generated in the cavity to inhibit energy loss from escaping via the aperture.

Clause 4. The receiver of any preceding clause, further comprising a plurality of input ports affixed to one or more edges of the aperture and an absorber adjacent openings of the input ports, the absorber configured to receive sunlight directed outside said one or more edges of the aperture that heats the absorber, which in turn heats air passing through the input ports and through one or more pores in the absorber, the heated air directed through the aperture into the cavity.

Clause 5. The receiver of any preceding clause, wherein the input ports are affixed to left and right edges of the aperture.

Clause 6. The receiver of Clause 5, wherein the input ports are affixed to top and bottom edges of the aperture.

Clause 7. The receiver of any preceding clause, wherein the members extend linearly in a vertical direction.

Clause 8. The receiver of any preceding clause, wherein the members are slats, semi-circular rods or tubular rods.

Clause 9. The receiver of any preceding clause, wherein the output manifold is a plurality of output manifolds, each output manifold in fluid communication with two or more of the plurality of output ports.

Clause 10. The receiver of any preceding clause, wherein the plurality of side walls include insulation material configured to inhibit a loss of heat through radiation or convection.

Clause 11. A solar power tower for a solar power plant, comprising:
one or more receivers at a top portion of the solar power tower, each receiver comprising
   a housing including
      an aperture on a front side of the housing,
      a plurality of side walls adjacent the aperture and extending rearward therefrom,
      an absorber that extends rearward of the sidewalls, the absorber comprising a porous material with a plurality of pores that allow airflow across the absorber,
      a cavity bounded by the aperture, the side walls and the absorber, and
      a plurality of parallel and spaced apart members that extends across the aperture, a gap defined between each pair of members;
   a plurality of output ports proximate the absorber and in fluid communication with the cavity via the plurality of pores in the absorber;
   an output manifold in fluid communication with the plurality of output ports; and
   a plurality of input ports affixed to one or more edges of the aperture and a second absorber adjacent openings of the input ports,
wherein the aperture is configured to receive sunlight from one or more heliostats therethrough to heat air in the cavity via the absorber, the aperture also configured to receive heated air via the gap between each pair of members, the heated air passing through the pores in the absorber and into the output ports and output manifold, and wherein the second absorber is configured to receive sunlight directed outside said one or more edges of the aperture that heats the second absorber, which in turn heats air passing through the input ports and through one or more pores in the second absorber, the heated air thereafter directed through the aperture into the cavity.

Clause 12. The solar power tower of Clause 11, wherein the members are made of glass.

Clause 13. The solar power tower of any of Clauses 11-12, wherein the members are configured to absorb thermal radiation generated in the cavity to inhibit energy loss from escaping via the aperture.

Clause 14. The solar power tower of any of Clauses 11-13, wherein the input ports are affixed to left and right edges of the aperture.

Clause 15. The solar power tower of Clause 14, wherein the input ports are affixed to top and bottom edges of the aperture.

Clause 16. The solar power tower of any of Clauses 11-15, wherein the members extend linearly in a vertical direction.

Clause 17. The solar power tower of any of Clauses 11-16, wherein the output manifold is a plurality of output manifolds, each output manifold in fluid communication with two or more of the plurality of output ports.

Clause 18. The solar power tower of any of Clauses 11-17, wherein the plurality of side walls include insulation material configured to inhibit a loss of heat through radiation or convection.

Clause 19. The solar power tower of any of Clauses 11-18, further comprising one or more inflow conduits in fluid communication with the output manifold and that receive heated air from the one or more receivers and direct it toward one or both of a hot thermal storage tank and a heat utilization module, and one or more outflow conduits that direct air from one or both of the hot thermal storage tank and the heat utilization module to the input ports.

Clause 20. The solar power tower of any of Clauses 11-19, wherein the one or more receivers are two receivers oriented in different directions.

Clause 21. The solar power tower of Clause 20, wherein the two receivers are oriented approximately 90 degrees apart.

Clause 22. The solar power tower of any of Clauses 11-21, wherein the members are slats, semi-circular rods or tubular rods.

Clause 23. The solar power tower of any of Clauses 11-22, wherein the one or more receivers include the receiver of any of Clauses 1-10.

One or more embodiments disclosed herein may be implemented with one or more computer readable media, wherein each medium may be configured to include thereon data or computer executable instructions for manipulating data. The computer executable instructions include data structures, objects, programs, routines, or other program modules that may be accessed by a processing system, such as one associated with a general-purpose computer, processor, electronic circuit, or module capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. Examples of mass storage devices incorporating computer readable media include hard disk drives, magnetic disk drives, tape drives, optical disk drives, and solid state memory chips, for example. The term processor as used herein refers to a number of processing devices including electronic circuits such as personal computing devices, servers, general purpose computers, special purpose computers, application-specific integrated circuit (ASIC), and digital/analog circuits with discrete components, for example.

While certain embodiments have been described herein, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, less than or equal to 10 degrees, less than or equal to 5 degrees, less than or equal to 3 degrees, less than or equal to 1 degree, or less than or equal to 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed devices.

What is claimed is:

1. A receiver for a solar power plant, comprising:
a housing comprising:
an aperture on a front side of the housing,
a plurality of sidewalls adjacent the aperture and extending rearward therefrom,
an absorber that extends rearward of the sidewalls, the absorber comprising a porous material with a plurality of pores that allow airflow across the absorber,
a cavity bounded by the aperture, the sidewalls and the absorber, and
a plurality of parallel and spaced apart members that extends across the aperture, a gap defined between each pair of members;
a plurality of output ports proximate the absorber and in fluid communication with the cavity via the plurality of pores in the absorber; and
an output manifold in fluid communication with the plurality of output ports,
wherein the aperture is configured to receive sunlight from one or more heliostats therethrough to heat air in the cavity via the absorber, the aperture also configured to receive heated air via the gap between each pair of the members, the heated air passing through the pores in the absorber and into the output ports and the output manifold.

2. The receiver of claim 1, wherein the members are made of glass.

3. The receiver of claim 1, wherein the members are configured to absorb thermal radiation generated in the cavity to inhibit energy loss from escaping via the aperture.

4. The receiver of claim 1, further comprising a plurality of input ports affixed to one or more edges of the aperture and an absorber adjacent openings of the input ports, the absorber configured to receive sunlight directed outside said one or more edges of the aperture that heats the absorber, which in turn heats air passing through the input ports and through one or more pores in the absorber, the heated air directed through the aperture into the cavity.

5. The receiver of claim 4, wherein the input ports are affixed to left and right edges of the aperture.

6. The receiver of claim 5, wherein the input ports are affixed to top and bottom edges of the aperture.

7. The receiver of claim 1, wherein the members extend linearly in a vertical direction.

8. The receiver of claim 1, wherein the members are slats, semi-circular rods or tubular rods.

9. The receiver of claim 1, wherein the output manifold is a plurality of output manifolds, each output manifold in fluid communication with two or more of the plurality of output ports.

10. The receiver of claim 1, wherein the plurality of sidewalls include insulation material configured to inhibit a loss of heat through radiation or convection.

11. A solar power tower for a solar power plant, comprising:
one or more receivers at a top portion of the solar power tower, each receiver comprising:
a housing including:
an aperture on a front side of the housing,
a plurality of sidewalls adjacent the aperture and extending rearward therefrom,
an absorber that extends rearward of the sidewalls, the absorber comprising a porous material with a plurality of pores that allow airflow across the absorber,
a cavity bounded by the aperture, the sidewalls and the absorber, and
a plurality of parallel and spaced apart members that extends across the aperture, a gap defined between each pair of members;
a plurality of output ports proximate the absorber and in fluid communication with the cavity via the plurality of pores in the absorber;
an output manifold in fluid communication with the plurality of output ports; and
a plurality of input ports affixed to one or more edges of the aperture and a second absorber adjacent openings of the input ports,
wherein the aperture is configured to receive sunlight from one or more heliostats therethrough to heat air in the cavity via the absorber, the aperture also configured to receive heated air via the gap between each pair of the members, the heated air passing through the pores in the absorber and into the output ports and the output manifold, and wherein the second absorber is configured to receive sunlight directed outside said one or more edges of the aperture that heats the second absorber, which in turn heats air passing through the input ports and through one or more pores in the second absorber, the heated air thereafter directed through the aperture into the cavity.

12. The solar power tower of claim 11, wherein the members are made of glass.

13. The solar power tower of claim 11, wherein the members are configured to absorb thermal radiation generated in the cavity to inhibit energy loss from escaping via the aperture.

14. The solar power tower of claim 11, wherein the input ports are affixed to left and right edges of the aperture.

15. The solar power tower of claim 14, wherein the input ports are affixed to top and bottom edges of the aperture.

16. The solar power tower of claim 11, wherein the members extend linearly in a vertical direction.

17. The solar power tower of claim 11, wherein the output manifold is a plurality of output manifolds, each output manifold in fluid communication with two or more of the plurality of output ports.

18. The solar power tower of claim 11, wherein the plurality of sidewalls include insulation material configured to inhibit a loss of heat through radiation or convection.

19. The solar power tower of claim 11, further comprising one or more inflow conduits in fluid communication with the output manifold and that receive heated air from the one or more receivers and direct it toward one or both of a hot thermal storage tank and a heat utilization module, and one or more outflow conduits that direct air from one or both of the hot thermal storage tank and the heat utilization module to the input ports.

20. The solar power tower of claim 11, wherein the one or more receivers are two receivers oriented in different directions.

21. The solar power tower of claim 20, wherein the two receivers are oriented approximately 90 degrees apart.

22. The solar power tower of claim 11, wherein the members are slats, semi-circular rods or tubular rods.
